(19) United States
(12) Patent Application Publication
(10) Pub. No.: US 2009/0175234 A1
(43) Pub. Date: Jul. 9, 2009

(54) Enhanced Sub-Frame-Based-Framing for Wireless Communications

(75) Inventors: Udayan Dasgupta, Irving, TX (US); Muhammad Zubair Ikram, Richardson, TX (US); David Patrick Magee, Allen, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/350,523

(22) Filed: Jan. 8, 2009

Related U.S. Application Data
(60) Provisional application No. 61/019,810, filed on Jan. 8, 2008.

(51) Int. Cl. H04W 72/04; H04B 7/00

(52) U.S. Cl. 370/329; 370/310

(57) ABSTRACT

A method of performing wireless communications. The method comprises, at a transmitting station, encoding a plurality of symbols into a frame. The method further comprises, from the transmitting station, transmitting the frame via a wireless communication to a receiving station. The frame comprises a plurality of sub-frames, wherein a first sub-frame in the plurality of sub-frames consists of a first number of symbols and a second sub-frame in the plurality of sub-frames consists of a second number of symbols. Finally, the first number differs from the second number.

### CROSS-REFERENCES TO RELATED APPLICATIONS

This application claims priority to, the benefit of the filing date of, and hereby incorporates herein by reference, U.S. Provisional Patent Application 61/019,810, entitled “Enhancements to the Super-Frame/Sub-Frame-Based Framing Structure for 802.16m,” and filed Jan. 8, 2008.

### STATEMENT REGARDING FEDERALLY SPONSORED RESEARCH OR DEVELOPMENT

Not Applicable.

### BACKGROUND OF THE INVENTION

The preferred embodiments are in the field of wireless communications and are more specifically directed to enhanced hierarchical framing for wireless communications.

Advances in wireless communication technology, especially in recent years, have greatly improved not only the performance (i.e., data rate for a given error rate) at which wireless communications can be carried out, but also have enabled the realization of additional functions and services by way of wireless communications. For example, wireless broadband communication in metro area networks is now becoming commonplace. An example of one type of wide area wireless network communications is referred to as “WiMAX”, corresponding to communications carried out under IEEE Standard for Local and metropolitan area networks, Part 16: Air Interface for Fixed Broadband Wireless Access Systems (IEEE Standard 802.16-2004, and all subsequent revisions). Of course, wireless local area networks (WLAN) are also now becoming commonplace and are capable of carrying traffic at very high data rates (e.g., 100 Mbit/sec) and for both fixed and mobile devices, there including by ways of example IEEE 802.16d, 802.16e, and 802.16m. Networks operating under the WiMAX standard, for example, are capable of carrying out multiple types of communications. These multiple communications “services” are typically supported by modern wireless devices, including laptop computers equipped with WiMAX network adapters, palm top computers or highly capable personal digital assistants (PDAs), and modern “smartphones” that support data services. As known in the art, these modern wireless devices and systems, communicating via a WiMAX or other metro or wider area wireless network, support multiple simultaneous wireless communications sessions.

Physically, a WiMAX metro area network is realized via base stations deployed within the physical service area with some frequency (e.g., on the order of a base station deployed every mile, to every several miles), similar to cellular telephone base stations and towers. A given base station is capable of communicating with nearby wireless client devices, typically referred to as “subscriber stations”, or often as “mobile stations” considering that these devices are typically portable computing and communications devices such as laptop or palmtop computers, smartphones, and the like. Each of the traffic flows between a mobile station and a base station is typically referred to as a “service flow”, in the context of WiMAX communications. For example, a VoIP call is carried out over one service flow, an email session is carried out over another service flow, and each web browsing session is carried out over another service flow.

Wireless communications under WiMAX occur through the communication of data packets. These data packets are communicated either in the downlink (DL), that is from base station to subscriber station, or the uplink (UL), that is from subscriber station to base station. In either the case of DL or UL, the packets are organized in the form of a data frame. Historically the WiMAX frame has been, and at least through the various evolution to 802.16m remains to be, 5 milliseconds (msec) in duration. The frame includes overhead or control information, typically located at the beginning of the frame and that relates to the data packets that are included in the remainder of the frame. Moreover, it is likely that the 5 msec duration will be maintained for future versions of WiMAX so as to support so-called “legacy” users, that is, to maintain a backward compatibility to the hardware and/or software that was created under earlier versions of the same standard.

As additional background, WiMAX communications are by way of Orthogonal Frequency Division Multiplex (OFDM) symbols. Typically, the various frequencies included within a symbol include up to three information types, namely: (i) data; (ii) pilot; or (iii) null. Data provides control information or actual information that represents the specific function served by the majority of the communicated data (e.g., voice data, email data, internet data, program data, and so forth). Pilot information provides a pattern over multiple symbols that is known to the receiver and repeats over a number of symbols and is used by the receiver for synchronization and channel estimation. Null symbol information represents an intentional empty signal, such as for guard bands or to fill a number of symbol vacancies so that a total number of symbols are accounted for in a given instance, such as filling a total number of symbols in a frame or portion of the frame.

Note also under WiMAX that symbols are grouped into zones. Specifically, all symbols in a zone share a common so-called permutation. The permutation is a particular technique for improving SNR of the symbols when they are received and decoded, akin therefore or in some instances considered analogous to interleaving or some other randomization technique for improving noise and other resistance of the data as it is communicated in the wireless channel. Thus, for a given zone, there is associated overhead in the communication that identifies the type of zone so that the receiver can properly decode the data in that zone. The first column of Table 1, immediately below, illustrates the various different zone permutations under IEEE 802.16e.

TABLE 1
Permutation

DL FUSC
DL PUSC
DL AMC/DL Band AMC
UL PUSC
UL AMC

Having introduced permutations in WiMAX zones, note that a zone may be further broken down into one or more slots, where each slot contains a required integer number of symbols. The number of required symbols in a given slot depends on the type of permutation for that slot, as shown in the following Table 2 under IEEE 802.16e

TABLE 2

| Permutation | Symbols-per-slot |
|---|---|
| DL FUSC | 1 |
| DL PUSC | 2 |
| DL AMC/DL Band AMC | 3 |
| UL PUSC | 3 |
| UL AMC | 3 |

Thus, the first column of Table 2 repeats the permutations from Table 1, while the second column of Table 2 indicates that each permutation has a defined number of symbols that consist of a so-called slot for that permutation. For example, for the Full Usage of Sub-channels downlink (DL FUSC) permutation, then a slot of data under that permutation contains only one symbol. As another example, however, for the Adaptive Modulation and Coding uplink (UL AMC), then a slot of data under that permutation contains three symbols. The remaining examples of Table 1 will be understood by one skilled in the art.

Given the previous background, certain modifications to the frame structure were proposed in C80216m-07_{—}354 [3] submitted to the IEEE 802.16 Broadband Wireless Access Working Group. The proposal suggests the use of a 20 msec super-frame consisting of four 5 msec frames (similar to the 802.16e frames). In addition, however, each 5 msec frame would be divided further into a number of sub-frames, where every sub-frame is six symbols wide. Additionally, Frame 0 of the four frame super-frame would contain system configuration, paging, and other broadcast information applicable to the whole super-frame. In the time division duplex (TDD) mode of operation, each sub-frame could be assigned to either UL or DL communications, in contrast to a prior version wherein the entire frame consisted only of 1 DL and 1 UL sub-frame. As a result, latency can be reduced by the proposed approach, as compared to the earlier 802.16, because there is the ability to have multiple UL-DL switch points within a 5 msec WiMAX frame, as compared to only one in 802.16e.

As detailed later, it is recognized in connection with the preferred embodiments that while the previous standards and proposals may provide for effective wireless communications, there also are certain drawbacks. Thus, the preferred embodiments seek to improve upon the prior art, as demonstrated below.

### BRIEF SUMMARY OF THE INVENTION

In a preferred embodiment, there is a method of performing wireless communications. The method comprises, at a transmitting station, encoding a plurality of symbols into a frame. The method further comprises, from the transmitting station, transmitting the frame via a wireless communication to a receiving station. The frame comprises a plurality of sub-frames, wherein a first sub-frame in the plurality of sub-frames consists of a first number of symbols and a second sub-frame in the plurality of sub-frames consists of a second number of symbols. Finally, the first number differs from the second number.

Other aspects are also disclosed and claimed.

### BRIEF DESCRIPTION OF THE SEVERAL VIEWS OF THE DRAWING

FIG. 1 is an electrical diagram, in block form, of a wireless broadband metro area network into which the preferred embodiments may be implemented by way of example.

FIG. 2 is an electrical diagram, in block form, of a base station or subscriber station in the network of FIG. 1, constructed according to the preferred embodiment of the invention.

FIG. 3 illustrates a block data diagram of a superframe SPRF_{P} consistent with a previous WiMAX proposal.

FIG. 4 illustrates a superframe SPRF_{I} in accordance with certain aspects of the inventive scope.

FIG. 5 illustrates a superframe SPRF_{I} with frames either separated in time or in different networks and in accordance with certain aspects of the inventive scope.

### DETAILED DESCRIPTION OF THE INVENTION

The preferred embodiments are described in connection with a preferred implementation into a base station and subscriber/mobile station in a “WiMAX” wireless broadband network, operating under the IEEE 802.16 standard, as it is contemplated that this implementation is especially beneficial when realized in such an environment. However, it is also contemplated that other preferred embodiments may be created to provide similar important benefits in other types of networks, particularly those in which data is communicated in a framing structure. Accordingly, it is to be understood that the following description is provided by way of example only, and is not intended to limit the true inventive scope as claimed.

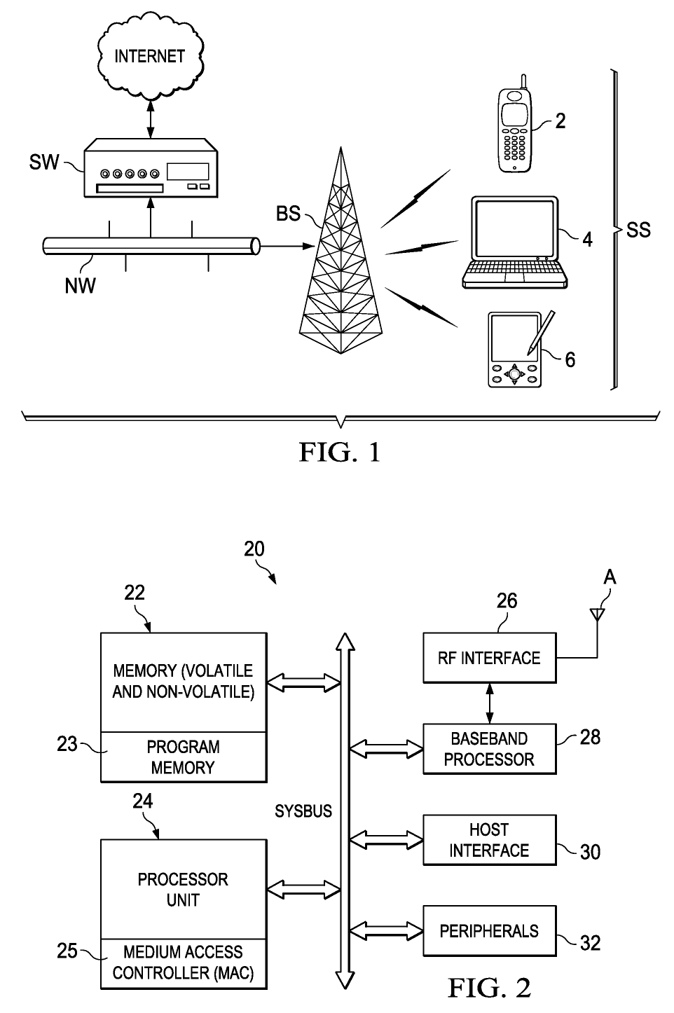

FIG. 1 illustrates a wireless metro area network (MAN) into which the preferred embodiments are implemented. In the network of FIG. 1, a base station BS corresponds to infrastructure at a fixed location, including an antenna and communication circuitry. Communications occur between base station BS and various mobile stations or stationary subscriber stations in the vicinity of base station BS, and for sake of simplicity, while some of these stations may be potentially mobile such stations are hereafter referred to as subscriber stations SS. It is contemplated, in the MAN context as illustrated in FIG. 1, that wireless communications between base station BS and subscriber stations SS can be carried over distances ranging up to several miles. The particular performance and distance over which such communications can be carried out will vary, of course, with atmospheric conditions and with the nature of various attenuators (e.g., buildings, mountains) in the vicinity of base station BS.

As noted above and as evident from FIG. 1, base station BS includes an antenna tower or other antenna structure suitable for supporting communications over its coverage area. Base station BS also includes circuitry (not shown) and other support equipment suitable for communicating over backbone network NW into a wide area network (WAN) context. The example of FIG. 1 illustrates switch equipment SW as residing on backbone network NW, through which base station BS is able to communicate to and from the global Internet and with various other devices and network elements coupled to the Internet, via Internet Protocol (IP) communications and the like.

In the example of FIG. 1, it is contemplated that many types of subscriber stations SS may communicate over the wireless MAN supported by base station BS. A smartphone 2 is one example of subscriber station SS, and in this example includes not only cellular telephone connectivity, but also circuitry for connecting to the wireless MAN supported by base station BS; in this manner, smartphone 2 can operate using such communications services as Internet web browsing, the sending and receipt of email messages, and other services such as Voice over Internet Protocol (VoIP) telephony. It is contemplated that smartphone 2 is thus capable of both cellular and wireless broadband communications, and supporting services such as those contemplated according to so-called “3G” or “LTE” (Long Term Evolution) wireless services. Another type of subscriber station SS that may communicate in the network of FIG. 1 is illustrated by a laptop computer 4, by way of a WiMAX or wireless broadband network adapter; laptop computer 4 of course includes the circuitry, display, and software capability for carrying out services such as Internet web browsing, email communications, and VoIP telephony and the like. Similarly, a personal digital assistant (PDA) 6 in FIG. 1 represents handheld wireless broadband capable devices, including not only PDAs but also palmtop or tablet computers, and the like, such devices also supporting the services contemplated in connection with wireless broadband connectivity.

FIG. 2 illustrates the construction of network station 20 according to a preferred embodiment. This generalized construction of network station 20 as shown in FIG. 2 is contemplated to be applicable to either base station BS or to subscriber station SS, such as smartphone 2, laptop computer 4, PDA 6, or a wireless broadband adapter or function within such subscriber station devices. In this context, therefore, network station 20 may be representative of the entire device or system, or instead of only an adapter, card, or particular built-in or added function in base station BS or subscriber station SS. Furthermore, those skilled in the art having reference to this specification will understand that the architecture illustrated in FIG. 2 is presented by way of example only, and that many variations to this architecture alternatively may be used to realize network station 20.

Network station 20 is contemplated to be implemented by way of a programmable digital computing system. As such, network station 20 includes a processor unit 24, which may be implemented as a general purpose or application-specific processor, as determined by the system designer, capable of executing instructions in computer programs to carry out the overall processing and functionality of network station 20 and as detailed later such functionality includes the transmission and receipt of a framing architecture that includes packet frames with varying sized sub-frames based on the WiMAX zone permutations. In FIG. 2, network station 20 also includes memory 22, preferably including both volatile random access memory (RAM) and also non-volatile memory, for example read-only memory (ROM), flash memory, or some other type of programmable non-volatile memory. It is contemplated that at least a portion of memory 22 constitutes program memory 23, for storing instruction sequences or software routines that are executable by processor unit 24 in its operation. Typically, program memory 23 will be realized by non-volatile memory within memory 22 in one way or another, in which case the program instructions may be fetched from such non-volatile memory within memory 22 serving as program memory. Alternatively, some sort of boot-loading or other software management function may be executed on startup of network station 20, so that the program instructions (and thus program memory 23) are deployed at least in part into volatile memory within memory 22. Of course, the various portions of memory 22 (data memory and program memory; volatile and non-volatile memory; etc.) may be realized in the same memory address space or in different memory address spaces, according to the particular architecture. In the example of FIG. 2, processor unit 24 accesses memory 22 via system bus SYSBUS. A portion of processor unit 24 in network station 20 according to the preferred embodiments is shown in FIG. 2 as corresponding to medium access controller (MAC) 25. MAC controller 25 may be a separate integrated circuit, or separate processor core, within processor unit 24, or alternatively may be realized by the same processor core of processor unit 24 used to perform various data processing functions within network station 20.

According to a preferred embodiment, a methodology is provided whereby data packets are communicated in the form of sub-frames between a receiving station (e.g., one of base station BS or any subscriber station SS) and a transmitting station (e.g., also one of base station BS or any subscriber station SS), as further detailed below. It is contemplated that various processing circuitry in network station 20 may accomplish this methodology, as either the receiving station or the transmitting station, by the use of program instructions. Thus, such program instructions may be executed by a MAC controller 25 or such other processing circuitry in network station 20, and in doing so it carries out the operations of the preferred embodiments as described later. In this regard, it is contemplated that such program instructions or a portion thereof may be provided to network station 20 by way of computer-readable media, or otherwise stored in program memory 23 such as by way programming program memory 23 during or after manufacture, or provided by way of other conventional optical, magnetic, or other storage resources at those computer resources, or communicated to network station 20 by way of an electromagnetic carrier signal upon which functional descriptive material corresponding to that computer program or portion thereof is encoded.

Other system functions in network station include peripherals 32, shown in FIG. 2 as coupled to system bus SYSBUS, for example including input/output functions such as one or more serial ports, timer circuitry, and the like, as suitable for the particular function of network station 20. Host interface 30 is coupled to system bus SYSBUS and serves as an interface to a host computer or other system. Host interface 30 is particularly useful if network station 20 is implemented as an adapter to a larger system, such as in the case of base station BS or laptop computer 4. In that case, the adapter of network station 20 would communicate with the host system by way of this host interface 30.

Network station 20 also includes the appropriate circuitry for communicating in a wireless broadband network such as that shown in FIG. 2. In this arrangement, a baseband processor 28, coupled to system bus SYSBUS, may be realized by a digital signal processor or other programmable logic and performs the appropriate encoding and decoding operations, digital filtering, modulation and demodulation, as useful and appropriate for the physical layer requirements of the wireless communications protocol supported by network station 20. An RF interface 26 in network station 20 is preferably realized by the appropriate digital and analog circuitry for driving radio frequency (RF) signals being transmitted, and for receiving RF signals, via antenna A. RF interface 26 communicates with baseband processor 28.

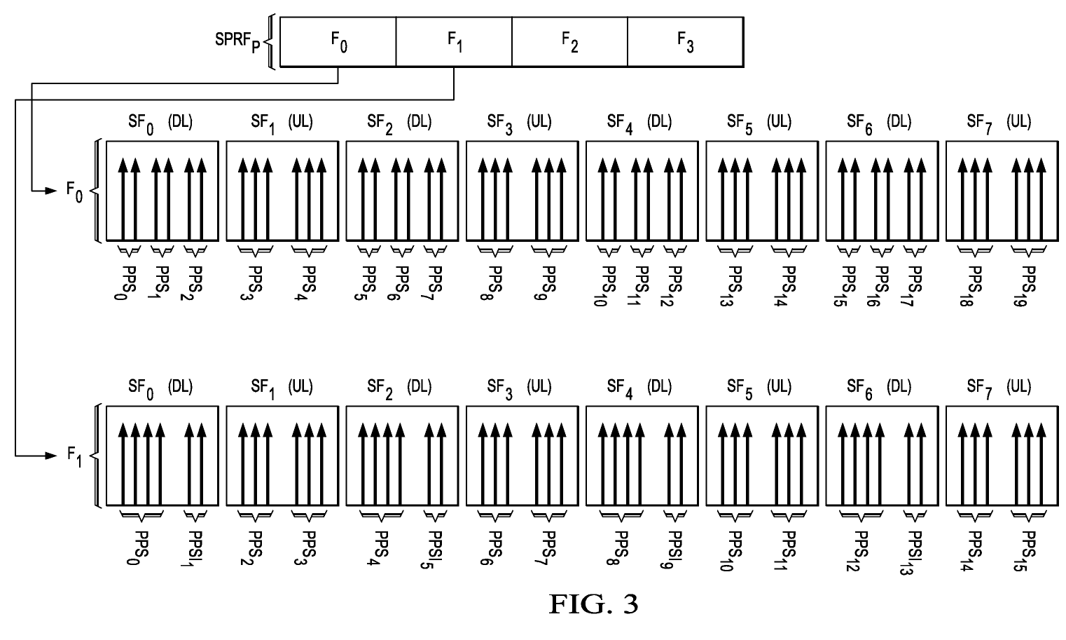

As introduced earlier, according to a preferred embodiment, network station 20 is programmed, for example by way of instructions stored in program memory 23 and executable by MAC controller 25, to communicate (i.e., both encode/transmit and receive/decode) packet data in frames and those frames are defined by certain inventive aspects detailed herein. In order to further appreciate certain aspects of the inventive scope, attention is first turned to a specific drawback recognized in connection with the preferred embodiments and of the above-introduced proposal C80216m-07_{—}354 [3]. Particularly, FIG. 3 illustrates a block data diagram of a superframe SPRF_{P} consistent with that proposal and communicated by and between network stations that are of the form of network station 20 (or a comparable version thereof). Superframe SPRF_{P} consists of four 5 msec frames F₀ through F₃, where recall that each frame Fₓ is divided into sub-frames and each such sub-frame consists of six symbols. By ways of example, each of frames F₀ and F₁ is shown in greater detail and each includes eight such sub-frames SF₀ through SF₇. As examples in frame F₀, sub-frames SF₀, SF₂, SF₄, and SF₆ are downlink (DL) sub-frames, and sub-frames SF₁, SF₃, SF₅, and SF₇ are uplink (UL) sub-frames, and similarly in frame F₁ sub-frames SF₀, SF₂, SF₄, and SF₆ are DL sub-frames, and sub-frames SF₁, SF₃, SF₅, and SF₇ are UL sub-frames. Further, vertical arrows are shown in each sub-frame as a representation of the six-symbols communicated in each respective sub-frame. Additional details relating to these sub-frames are discussed below.

The sub-frames of frame F₀ are intended to illustrate that pilot information is included with each symbol and for an example of a WiMAX permutation where two symbols are required to provide a complete pilot pattern sequence for a DL sub-frame and where three symbols are required to provide a complete pilot pattern sequence for an UL sub-frame. Thus, in the DL sub-frame SF₀, the first and second symbols shown (from left to right) in sub-frame SF₀ provide a complete pilot pattern sequence PPS₀; as known in the art and introduced earlier, therefore, such pilot information is used to improve the decoding of the data that accompanies those symbols. Similarly, therefore, the third and fourth symbols in sub-frame SF₀ provide a complete pilot pattern sequence PPS₁, and the fifth and sixth symbols in sub-frame SF₀ provide a complete pilot pattern sequence PPS₂. In a similar fashion FIG. 3 also illustrates that DL sub-frame SF₂ of frame F₀ includes three complete pilot pattern sequences, PPS₅, PPS₆, and PPS₇, each consisting of two pilot symbols, where for sake of example it may be assumed that the permutation of sub-frame SF₂ is the same as that of sub-frame SF₀ (although the two sub-frames could be different permutations). As yet another example of a DL sub-frame in frame F₀, DL sub-frame SF₄ of frame F₀ includes three complete pilot pattern sequences, PPS₁₀, PPS₁₁, and PPS₁₂, each consisting of two pilot symbols. However, also in frame F₀, note that sub-frame SF₁ is intended to illustrate an UL sub-frame and also with a different WiMAX permutation than that used for DL sub-frames SF₀, SF₂, SF₄, and SF₆. Specifically, for UL sub-frame SF₁ assume that its WiMAX permutation requires three pilot symbols in a complete pilot pattern sequence; therefore, as illustrated, the first through third symbols in UL sub-frame SF₁ provide a complete pilot pattern sequence PPS₃, and the fourth through sixth symbols in UL sub-frame SF₁ provide a complete pilot pattern sequence PPS₄. Accordingly, there is a change in zone between sub-frames SF₀ and SF₁. The remaining examples in frame F₀ will be understood by one skilled in the art.

Continuing with FIG. 3, the sub-frames of frame F₁ are again intended to illustrate pilot information included with each symbol and for an example of a WiMAX permutation, but in the example of frame F₁ a drawback is illustrated for certain sub-frames where, for instance, four symbols are required to provide a complete pilot pattern sequence, as may occur for DL sub-frames. Given these parameters, the first through fourth symbols in DL sub-frame SF₀ provide a complete pilot pattern sequence PPS₀. However, note that following that pilot pattern sequence PPS₀, only two symbols remain in sub-frame SF₀ because it is required to consist of six symbols; therefore, the remaining two symbols in sub-frame SF₁ only provide two additional pilot symbols and cannot complete an additional complete repetition of the four-symbol pilot pattern sequence, so for sake of reference they are identified as an incomplete pilot pattern sequence PPSI₁. As a result, therefore, it is anticipated that some technique will be used to extrapolate from the pilot information provided by the fifth and sixth symbols to decode the data of those symbols, rather than having a full pilot pattern sequence (of four symbols) to perform that decoding. Thus, it is possible, if not likely, that the decoding of the last two symbols in sub-frame SF₀ of frame F₁ will be less accurate than that of the first four symbols in that same sub-frame, as the latter have a full pilot pattern sequence with which to perform the decode. The remaining DL sub-frames SF₂, SF₄, and SF₆ of frame F₁ in FIG. 3 each illustrate a repetition of the same drawback as shown and described with respect to sub-frame SF₀, that is, in each of those DL sub-frames, there is at least one incomplete pilot pattern sequence, as will now be evident to one skilled in the art. Moreover, while not shown, note that such a drawback also could be possible in UL sub-frames depending on a permutation provided for such a sub-frame.

From the above, FIG. 3 therefore illustrates the recognition in connection with the preferred embodiments that the aforementioned WiMAX proposal effectively imposes the limitation that a given sub-frame may not necessarily include an integer multiple number of pilot pattern sequences. And, as a result of this limitation, one drawback is that data may be decoded unsatisfactorily or inefficiently in response to an incomplete pilot pattern sequence. Thus, a preferred embodiment described below addresses this drawback and provides further improvements as well.

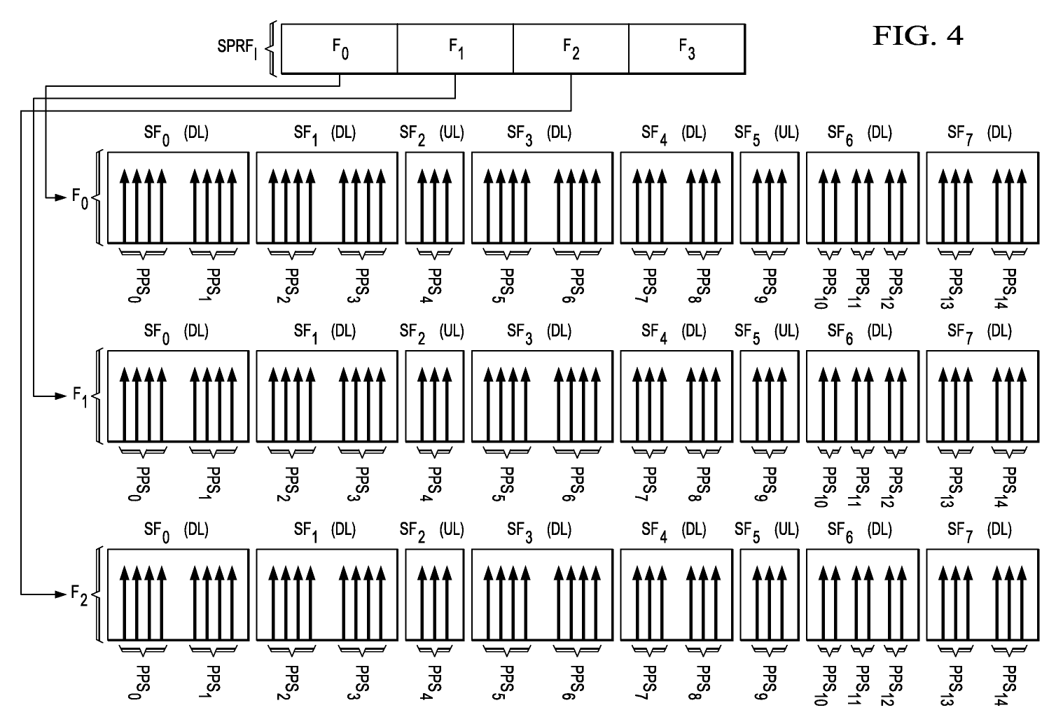

Recalling that a preferred embodiment network station 20 is also programmed to communicate (i.e., both encode/transmit and receive/decode) packet data in frames, FIG. 4 illustrates a superframe SPRF_{I} in accordance with certain aspects of the inventive scope. Superframe SPRF_{I} preferably comprises four frames F₀ through F₃, and in a preferred embodiment each frame Fₓ is also of a same duration as the framing architecture supported by legacy users in the system; thus, in a preferred embodiment where superframe SPRF_{I} is incorporated into a WiMAX network, then each frame Fₓ is 5 msec in duration.

Also in the preferred embodiment as shown in FIG. 4, each frame Fₓ is divided into sub-frames. Thus, for sake of example and illustration, the first three of the four frames in FIG. 4 are shown in greater detail. Additionally, as with FIG. 3, in FIG. 4 again vertical arrows are shown in each sub-frame as a representation of the symbols communicated in the respective sub-frame. Note, however, that in a preferred embodiment each such sub-frame is not constrained to a same number symbols, in contrast to the six symbols required in each such sub-frame in the above-detailed WiMAX proposal. For example, one skilled in the art may readily see from the graphical depiction of frame F₀ in FIG. 4 that sub-frames SF₀, SF₁, and SF₃ each consist of eight symbols, sub-frames SF₂ and SF₅ each consist of three symbols, and sub-frames SF₄, SF₆, and SF₇ each consist of six symbols. Thus, in a preferred embodiment the number of symbols per sub-frame may vary between different sub-frames of a frame, for reasons and with benefits further appreciated later.

In one aspect of superframe SPRF_{I}, each sub-frame consists of an integer multiple of complete pilot pattern sequences, as is now explored. First, in FIG. 4 again the sub-frames of frame F₀ are intended to illustrate that pilot information is included with each symbol. However, in FIG. 4, and further in part to illustrate inventive aspects, there are different examples of WiMAX permutations, where differing numbers of symbols are required to provide a complete pilot pattern sequence in different sub-frames. Looking to sub-frame SF₀ by way of example, it is a DL sub-frame with eight symbols, and where the first through fourth symbols shown (from left to right) in sub-frame SF₀ provide a complete pilot pattern sequence PPS₀, and as known in the art and introduced earlier, therefore, such pilot information is used to improve the decoding of the data that accompanies those symbols. Similarly, therefore, the fifth through eighth symbols in sub-frame SF₀ provide a complete pilot pattern sequence PPS₁. Given the preceding, note a key benefit exemplified by sub-frame SF₀ of frame F₀ in superframe SPRF_{I}, as compared to sub-frame SF₀ of frame F₁ in superframe SPRF_{P}. Particularly, sub-frame SF₀ of frame F₀ in superframe SPRF_{I} consists of an integer multiple of complete pilot pattern sequences, namely, there are two complete pilot pattern sequences PPS₀ and PPS₁ in sub-frame SF₀. As a result, therefore, the first set of four symbols in sub-frame SF₀ may be decoded by a receiver of superframe SPRF_{I} in view of the complete pilot pattern sequences PPS₀, and the second set of four symbols in sub-frame SF₀ may be decoded by a receiver of superframe SPRF_{I} in view of the complete pilot pattern sequences PPS₁. Thus, there is no need to interpolate or extrapolate a partial pilot pattern sequence so as to decode the received symbols, thereby improving data accuracy over the prior proposal.

In a similar fashion, FIG. 4 also illustrates that sub-frame SF₁ of frame F₀ consists of two complete pilot pattern sequences, PPS₂ and PPS₃, each consisting of four pilot symbols. Thus, for sake of example one may assume that the permutation of sub-frame SF₁ is the same as that of sub-frame SF₀, thereby indicating that the permutation zone includes both sub-frames SF₀ and SF₁. Once again, therefore, each four-symbol set of data in sub-frame SF₁ may be decoded in view of the respective four-symbol complete pilot pattern sequences included in that sub-frame.

Continuing with the illustration of frame F₀ in FIG. 4, its third sub-frame SF₂ consists of a different number of symbols than included in either of sub-frames SF₀ and SF₁, where each of sub-frames SF₀ and SF₁ consists of eight symbols while sub-frame SF₂ consists of only three symbols. However, sub-frame SF₂, like sub-frames SF₀ and SF₁, again consists of an integer multiple of pilot pattern sequences. Specifically, sub-frame SF₂ illustrates an example of a WiMAX (or other) permutation that includes three symbols in a complete pilot pattern sequence PPS₄ and, hence, sub-frame SF₂ includes one complete pilot pattern sequence. As a result, the data in sub-frame SF₂ may be decoded in view of the one completed pilot pattern sequence included in that sub-frame.

The remaining sub-frames in FIG. 4 illustrate other alternatives where each sub-frame includes consists of an integer multiple of complete pilot pattern sequences, and in various instances a different number of symbols may be included in a sub-frame so as to achieve this common aspect. For example, where sub-frames SF₀ and SF₁ each consist of eight symbols (as does sub-frame SF₃), and sub-frame SF₂ (and sub-frame SF₅) consists of three symbols, as yet a different instance sub-frame SF₄ (or sub-frame SF₇) includes a total of six symbols that provide the integer number two of complete pilot pattern sequences; particularly, in the example of sub-frame SF₄, each complete pilot pattern sequence consists of three symbols, that is, it includes one three-symbol complete pilot pattern sequence PPS₇ and one three-symbol complete pilot pattern sequence PPS₈. Once more, therefore, each three symbol set of data in sub-frame SF₄ may be decoded in view of the respective complete three symbol pilot pattern sequence included in that sub-frame. Lastly, note that sub-frame SF₆ also consists of six symbols as does sub-frame SF₄, but in sub-frame SF₆ there are only two pilot symbols in a complete pilot pattern sequence and an integer multiple three of those sequences in the entire sub-frame.

Having detailed the illustrated examples in FIG. 4, note further that other sized sub-frames are contemplated in the inventive scope and that include an integer multiple of complete pilot pattern sequences. Indeed, the illustration of sub-frames SF₀ and SF₁ as separate sub-frames is solely by way of example, where in fact if the symbols of those sub-frames are of the same permutation that requires four symbols for a complete pilot pattern sequence, then per the preferred embodiment each sub-frame can have any integer multiple of those four symbols. Thus, in one alternative approach, sub-frame SF₀ could be halved into two sub-frames, where each of those two sub-frames consists of only four symbols, yet those four symbols thereby provide one complete pilot pattern sequence. Or, in another alternative approach, sub-frames SF₀ and SF₁ could be combined into a single sub-frame consisting of sixteen symbols, where each set of four symbols in the sixteen provides one complete pilot pattern sequence, for a total therefore of four complete pilot pattern sequences in the 16-symbol sub-frame. Numerous other examples may be ascertained by one skilled in the art.

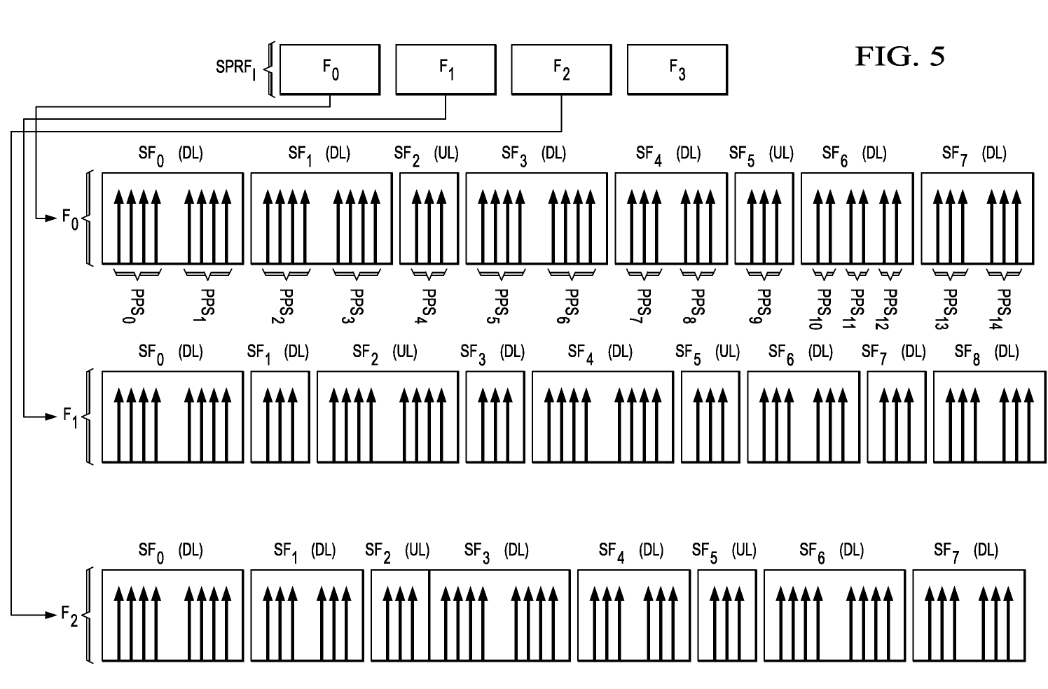

FIG. 5 illustrates additional frames that may be included in different superframes SPRF_{I} also within the inventive scope, that is, each frame illustrated in FIG. 5 may be in a same network but preferably separated from the other frames in time (e.g., hours or even days or months) or indeed each frame illustrated in FIG. 5 may be in a different respective superframe of a different respective network. In any event, the sub-frames of frames F₂ and F₃ illustrate alternatives from frame F₁, where frame F₁ was described above in connection with FIG. 4. Each sub-frame Fₓ consists of an integer multiple of complete pilot pattern symbols sequences shown as a group of vertical arrows, and in various instances a different number of symbols may be included in a sub-frame so as to achieve this common aspect. Further, a comparison of certain frames from FIGS. 3 and 5 reveals another benefit of the above-described preferred embodiment in that it achieves in certain instances lower latency while permitting a beneficial split as between downlink and uplink communications. For example, note in FIG. 3 that frame F₁ has the best achievable latency in that system when there is a switch between DL and UL every sub-frame, and in which case a total of 12 symbols are communicated between one instance of the beginning of DL communications followed by UL communications and the next instance of the beginning of DL communications, such as from sub-frame SF₀ to sub-frame SF₂. In other words, the best latency in FIG. 3 is restricted because superframe SPRF_{P} requires that every sub-frame has the same number of symbols, that is, six symbols. The effects of such latency are important in various instances. For example, in WiMAX there is an automatic repeat request (ARQ) protocol or sub-protocol under which a transmitting station sends information and then awaits an acknowledgement by the receiving station before the transmitting station sends any additional information to the receiver station; in addition, in WiMAX, a subscriber station must request bandwidth from the base station and only upon receipt from the base station of such bandwidth, sometimes referred to as a reservation, is the subscriber station permitted to then communicate one or more packets to the base station. In either of these aspects, therefore, there is a latency of time when the subscriber station must await information from the base station. Looking then to FIG. 3, note that its fixed six-symbol sub-frame necessarily defines a minimum amount of time that a subscriber must wait, that is, for at least the time that it takes the base station to communicate a six-symbol sub-frame; this wait time is often referred to as latency between the DL and UL communications. In contrast, the preferred embodiment of FIG. 5 provides, in certain instances, a sub-frame of less than six symbols, and therefore in those instances, the latency between DL and UL is reduced as compared to that of the proposed framing architecture of FIG. 3. For example, looking to frame F₁ of FIG. 5, note that for the first six-sub-frames there is a repeated 11 symbol latency, which is therefore lower than the above-described 12 symbol latency from FIG. 3. Specifically in frame F₁ of FIG. 5, one skilled in the art will confirm that there are 11 symbols from the start of DL sub-frame SF₀ to the completion of the immediately-following UL sub-frame SF₁, after which is the start of the next DL sub-frame (i.e., sub-frame SF₂). Similarly, there are 11 symbols from the start of DL sub-frame SF₂ to the completion of the immediately-following UL sub-frame SF₃, after which is the start of the next DL sub-frame (i.e., sub-frame SF₄). Thus, in FIG. 5, latency is improved over FIG. 3 because superframe SPRF_{I} of FIG. 5 does not requires that every sub-frame has the same number of symbols, as does superframe SPRF_{P} of FIG. 3 which requires six symbols per sub-frame. In this regard, one skilled in the art may consider various aspects in determining when to take advantage of the low latency offered by the relatively smaller number of symbols in certain sub-frames. In addition, note that the preferred embodiment also permits greater latitude in apportioning bandwidth as between DL and UL communications. Specifically, note again with respect to frame F₁ in FIG. 3 that for its best latency, there is an even split between UL and DL communications (i.e., 6 symbols of DL for every 6 symbols of UL. In contrast, looking to frame F₁ in FIG. 4, it not only provides an improved latency as compared to frame F₁ in FIG. 3, but frame F₁ in FIG. 4 also permits the dominant amount of symbols to be used for DL communications (i.e., 8 symbols of DL for every 3 symbols of UL). Thus, with the preferred embodiment it may be possible to create short UL sub-frames of only three symbols, such as UL feedback, while dedicating the majority of time in a frame to downlink—even for low latency modes. Moreover, the preferred embodiment permits the use of relatively short sub-frames when desirable, such as in situations involving relatively fast channel variations. Still further, for illustrative purposes, FIG. 5 illustrates the additional examples in frames F₁ and F₂ (again, separated in time or in different networks) so as to illustrate still other combinations of varying symbol length sub-frames that achieve a relatively larger amount of DL communications versus UL communications, where in both frames F₁ and F₂ there are one or more instances where there is only a three symbol UL latency between the DL communication that immediately precedes and immediately follows the three-symbol latency.

Given the above, for sake of reference herein the least common multiple of the minimum number of symbols required to provide a complete sequence of pilot symbols and the number of symbols in a slot may be referred to as a “section.” For example, frame F₀ of FIG. 4 illustrates a section of size four (e.g., sequence PPS₀ of sub-frame SF₀), a section of size three (e.g., sequence PPS₄ of sub-frame SF₂), and a section of size two (e.g., sequence PPS₁₀ of sub-frame SF₆). With that definition of section, the preferred embodiments may further provide specifications indicating the number of symbols (i.e., sub-frame symbol duration) for the various WiMAX permutations, with examples of such specifications as shown in the following Table 3.

TABLE 3

| | | Section | Number of |
|---|---|---|---|
| Zone/permutation | Possible sub-frame | duration | sections per |
| Configuration | duration (symbols) | (symbols) | sub-frame |
| SISO DL FUSC | 6 | 2 | 3 |
| SISO DL PUSC | 6 | 2 | 3 |
| SISO/MIMO DLAMC | 6 | 3 | 2 |
| and DL Band AMC | | | |
| MIMO DL PUSC | 8 | 4 | 2 |
| SISO UL AMC | 6 | 3 | 2 |
| SISO UL PUSC | 3 | 3 | 1 |

Table 3 illustrates various UL and DL permutations and further considers both single input single output (SISO) and multiple input multiple output (MIMO) configurations. By way of example, therefore, for a SISO DL FUSC permutation, the section duration is two symbols as shown in the third column. Thereafter, either the fourth column may be established which thereby determines the second column as a product of the third and fourth columns, or the second column may be established as an integer multiple times the third column value and which thereby determines the fourth column as that integer multiple. Continuing therefore with the example of the SISO DL FUSC permutation and its section width of 2, then if in a given network it is desirable to communicate three sections (i.e., three complete pilot pattern sequences) in a sub-frame, then the total duration of the sub-frame to accomplish that goal is 6 symbols. Or, if alternatively for the SISO DL FUSC permutation it is determined that its sub-frame duration is six symbols, then since a section is two symbols in duration then the integer multiple of three sections will be achieved in that sub-frame. In an event, therefore, Table 3 provides examples of these values for the various permutations of Full Usage of Sub-channels (FUSC), Partial Usage of Sub-channels (PUSC), and Adaptive Modulation and Coding (AMC). Further, one skilled in the art may further modify the specifications identified in Table 3 as well as specify comparable values for newly-added permutations according to the teachings of this document as well as the skill in the art. For example, as mentioned above in connection with FIG. 4, recall that sub-frame SF₀ could be halved into two sub-frames if the pilot pattern sequence requires 4 symbols, in which case a corresponding row entry could be made in Table 3. Similarly, as also mentioned above in connection with FIG. 4, recall that sub-frames SF₀ and SF₁ could be combined into a single sub-frame consisting of sixteen symbols where each set of four symbols in the sixteen provides one complete pilot pattern sequence, in which case a corresponding row entry could be made in Table 3. Numerous other examples may be ascertained by one skilled in the art.

In another aspect of a preferred embodiment, the zone-to-subFrame mapping from Table 3 and for the entire super-frame may be part of the broadcast information transmitted at the beginning of the super-frame, or in an alternative embodiment it be communication as some other periodic broadcast message that is not included in each frame or super-frame to which it applies. Note that the latter approach would incur little signaling overhead so long as the specification of either column 2 or column 4 were fixed for a reasonable amount of time. Thus, in one approach, those specifications may be communicated only at limited times, such as with a first set of values for a first time of day (e.g., daytime) communications and in anticipation of the communications during that time and with a second set of values for communications at a second time of day that is hours apart from the first time (e.g., night time communications) and in anticipation of the communications during that time, where for example DL communications may be expected to be a larger percentage of overall communications during the night time period. Thus, between these two time changes, either the second or fourth column information (i.e., for every zone configuration, the sub-frame duration or number of sections per sub-frame) is known at both the transmitter and the receiver and need not be re-communicated, so there is little overall change in overhead as compared the approach of the fixed sub-frame proposal.

Attention is now directed to the prior art user allocation of time slots and the OFDMA frequency bands (or sub-channels) during downlink communications. Specifically, according to the WiMAX prior art, the base station may communicate in a frame both during time slots and along all sub-carriers. Thus, for each frame the base station allocates time slots, and in addition it allocates the OFDMA frequency bands of the sub-carriers, which thereby provides in effect a two-dimensional allocation space to specific subscriber stations during each frame. The base station informs the subscriber stations of the allocation by way of control information at the beginning of the frame, such as in the form of a MAP, to indicate a number of time slots and a number of sub-channels (e.g., 16), and each subscriber station that is to receive DL communications along a respective sub-channel and during a respective specific time slots.

In an alternative preferred embodiment, a change is also implemented as compared to the above-described prior art user allocation of time slots and OFDMA frequency bands during downlink (or uplink) communications. Particularly, in this preferred embodiment, it is recognized that sub-frames are necessarily shorter in duration that the duration of the entire frame. Moreover, it is further recognized that the wireless channel can be assumed to be invariant during the relatively shorter duration of the sub-channel. Accordingly, in an additional preferred embodiment, the downlink user allocations are specified by the base station as one dimensional within a sub-frame, such as in each DL sub-frame shown in FIG. 4 (or FIG. 5). As a result, during the complete time period occupied by a single sub-frame, multiple subscriber stations may be assigned to different respective logical frequency bands (or sub-channels) spanning the entire sub-frame. The benefit of this one-dimensional allocation in a sub-frame is a significant reduction in signaling overhead as compared to the overhead required for a MAP to indicate two-dimensional allocations over an entire frame as in the prior WiMAX approach. Moreover, also in this preferred embodiment, control information (e.g., MAP) for the allocations in a sub-frame are contained at the start of every sub-frame, which again may be contrasted to the control information at the beginning of every frame in the prior approach. The preferred embodiment approach per sub-frame reduces signaling overhead and allows for a per-user dedicated control channel, which in turn enables efficient signaling and blind coding rate detection at the subscriber station and it also facilitates low latency modes by permitting shorter times between successive downlink communications as discussed earlier.

From the preceding, it may be appreciated that the preferred embodiments provide a method and apparatus for a more flexible wireless framing architecture, where such flexibility can be added while minimizing overhead. The preferred embodiments have application in various wireless networks and are particularly well suited for present IEEE 802.16 technologies and may well be suitable for future versions thereof. Thus, these considerations and the described embodiments also demonstrate that while the present embodiments have been described in detail, various substitutions, modifications or alterations could be made to the descriptions set forth above without departing from the inventive scope, as is defined by the following claims.

1. A method of performing wireless communications, comprising:
at a transmitting station, encoding a plurality of symbols into a frame; and
from the transmitting station, transmitting the frame via a wireless communication to a receiving station;
wherein the frame comprises a plurality of sub-frames; and
wherein a first sub-frame in the plurality of sub-frames consists of a first number of symbols;
wherein a second sub-frame in the plurality of sub-frames consists of a second number of symbols; and
wherein the first number differs from the second number.

2. The method of claim 1 wherein each sub-frame in the plurality of sub-frames consists of pilot symbols representing an integer multiple number of complete pilot pattern sequences.

3. The method of claim 2 wherein the integer multiple number of complete pilot pattern sequences is selected from a group consisting of 1, 2, and 3.

4. The method of claim 2 wherein each of the complete pilot pattern sequences consists of a number of pilot symbols selected from a group consisting of 2, 3, and 4.

5. The method of claim 2 wherein the first number of symbols and the second number of symbols are selected from a group consisting of 3, 4, 6, and 8.

6. The method of claim 1 wherein the first number of symbols and the second number of symbols are selected from a group consisting of 3, 4, 6, and 8.

7. The method of claim 1 wherein the receiving station is selected from a group consisting of a phone, a computer, a personal digital assistant, and a wireless broadband adapter.

8. The method of claim 1:
wherein the frame comprises a first frame in a superframe comprising a plurality of frames;
wherein each frame in the plurality of frames comprises a plurality of sub-frames; and
further comprising, from the transmitting station, transmitting an indicator, representative of the first number of symbols and the second number of symbols, as applying to the plurality of frames in the superframe.

9. The method of claim 8:
wherein the first number is responsive to a first permutation applied to data in the first sub-frame;
wherein the second number is responsive to a second permutation applied to data in the first sub-frame; and
wherein the first permutation differs from the second permutation.

10. The method of claim 8 wherein the superframe comprises a first superframe and further comprising, from the transmitting station, transmitting in a plurality of successive superframes a respective indicator, for each superframe in the plurality of successive superframes, representative of a differing number for specifying a differing number of symbols in sub-frames of frames for each of the plurality of successive superframes.

11. The method of claim 8:
wherein the superframe comprises a first superframe and wherein the indicator comprises a first indicator;
and further comprising, from the transmitting station:
transmitting a second superframe, wherein the second superframe comprises a plurality of frames and wherein each frame in the plurality of frames of the second superframe comprises a plurality of sub-frames; and
transmitting a second indicator representative of differing numbers for specifying differing numbers of symbols in sub-frames of frames in the second superframe;
wherein the step of transmitting the first indicator occurs at a time that is separated in time from the step of transmitting the second indicator.

12. The method of claim 1:
wherein the first number is responsive to a first permutation applied to data in the first sub-frame;
wherein the second number is responsive to a second permutation applied to data in the first sub-frame; and
wherein the first permutation differs from the second permutation.

13. The method of claim 1 and further comprising, from the transmitting station, transmitting a plurality of receiving station indicators, wherein each receiving station indicator is for indicating a respective receiving station allocated to receive communications during an entire duration of a respective one of the plurality of sub-frames.

14. The method of claim 1 wherein the frame comprises a WiMAX frame.

15. The method of claim 1:
wherein each sub-frame in the plurality of sub-frames comprises one or more slots;
wherein each slot in the one or more slots consists of one or more pilot symbols to be decoded according to a respective permutation; and
wherein each sub-frame in the plurality of sub-frames consists of pilot symbols representing an integer multiple number of a least common multiple of a minimum number of symbols required to provide a complete sequence of pilot symbols and a number of symbols in a slot.

16. Apparatus for performing wireless communications, comprising:
circuitry for encoding a plurality of symbols into a frame; and
circuitry for transmitting the frame via a wireless communication to a receiving station;
wherein the frame comprises a plurality of sub-frames; and
wherein a first sub-frame in the plurality of sub-frames consists of a first number of symbols;
wherein a second sub-frame in the plurality of sub-frames consists of a second number of symbols; and
wherein the first number differs from the second number.

17. The apparatus of claim 16 wherein each sub-frame in the plurality of sub-frames consists of pilot symbols representing an integer multiple number of complete pilot pattern sequences.

18. The apparatus of claim 16 wherein the first number of symbols and the second number of symbols are selected from a group consisting of 3, 4, 6, and 8.

19. The apparatus of claim 16:
wherein the frame comprises a first frame in a superframe comprising a plurality of frames;
wherein each frame in the plurality of frames comprises a plurality of sub-frames; and
further comprising circuitry for transmitting an indicator, representative of the first number of symbols and the second number of symbols, as applying to the plurality of frames in the superframe.

20. The apparatus of claim 19:
wherein the first number is responsive to a first permutation applied to data in the first sub-frame;
wherein the second number is responsive to a second permutation applied to data in the first sub-frame; and
wherein the first permutation differs from the second permutation.

21. The apparatus of claim 19 wherein the superframe comprises a first superframe and further comprising circuitry for transmitting in a plurality of successive superframes a respective indicator, for each superframe in the plurality of successive superframes, representative of a differing number for specifying a differing number of symbols in sub-frames of frames for each of the plurality of successive superframes.

22. The apparatus of claim 19:
wherein the superframe comprises a first superframe and wherein the indicator comprises a first indicator;
and further comprising:
circuitry for transmitting a second superframe, wherein the second superframe comprises a plurality of frames and wherein each frame in the plurality of frames of the second superframe comprises a plurality of sub-frames; and
circuitry for transmitting a second indicator representative of differing numbers for specifying differing numbers of symbols in sub-frames of frames in the second superframe;
wherein the transmitting of the first indicator occurs at a different time than the transmitting of the second indicator.

23. The apparatus of claim 16:
wherein the first number is responsive to a first permutation applied to data in the first sub-frame;
wherein the second number is responsive to a second permutation applied to data in the first sub-frame; and
wherein the first permutation differs from the second permutation.

24. The apparatus of claim 16 and further comprising circuitry for transmitting a plurality of receiving station indicators, wherein each receiving station indicator is for indicating a respective receiving station allocated to receive communications during an entire duration of a respective one of the plurality of sub-frames.

25. The apparatus of claim 16 wherein the frame comprises a WiMAX frame.

26. The apparatus of claim 16:
wherein each sub-frame in the plurality of sub-frames comprises one or more slots;
wherein each slot in the one or more slots consists of one or more pilot symbols to be decoded according to a respective permutation; and
wherein each sub-frame in the plurality of sub-frames consists of pilot symbols representing an integer multiple number of a least common multiple of a minimum number of symbols required to provide a complete sequence of pilot symbols and a number of symbols in a slot.
